(19) United States
(12) Patent Application Publication
(10) Pub. No.: US 2012/0150471 A1
(43) Pub. Date: Jun. 14, 2012

(54) COLOR PROCESSING APPARATUS, COLOR PROCESSING METHOD AND STORAGE MEDIUM

(75) Inventor: Hiroyuki Muto, Kawasaki-shi (JP)

(73) Assignee: CANON KABUSHIKI KAISHA, Tokyo (JP)

(21) Appl. No.: 13/310,666

(22) Filed: Dec. 2, 2011

(30) Foreign Application Priority Data
Dec. 13, 2010 (JP) 2010-277429
Nov. 18, 2011 (JP) 2011-253138

(51) Int. Cl. G06F 19/00

(52) U.S. Cl. 702/104

(57) ABSTRACT

There is provided a color processing apparatus comprising: a first input unit configured to input a reference spectral reflectance obtained by measuring a patch image with a spectrophotometer serving as a reference unit; a second input unit configured to input a correction target spectral reflectance obtained by measuring the patch image with a spectrophotometer serving as a correction target unit; a correction coefficient generation unit configured to generate a correction coefficient between the correction target spectral reflectance and the reference spectral reflectance, for each wavelength; and a correction unit configured to correct, for each wavelength, the spectral reflectance measured by the correction target unit, using the correction coefficient.

### BACKGROUND OF THE INVENTION

2. Field of the Invention

The present invention relates to color processing for correcting output error between models of spectrophotometer.

2. Description of the Related Art

Heretofore, spectral color sensors which are spectrophotometers that receive reflected light from a sample and output a spectral reflectance indicating wavelength-specific reflectances are known. Generally the measured values of spectral color sensors differ slightly depending on the sensor model. Difference in measured values between sensor models includes intra-model difference (unit difference) that arises between individual sensors of the same model and inter-model difference (absolute value difference) that arises between different models. Intra-model difference is thought to originate in variation during manufacture, occurring due to factors such as variation in assembly and adjustment and sensitivity variation in light-receiving elements, for example. On the other hand, inter-model difference is thought to arise as a result of various factors, such as differences in illumination between sensor models, differences in light-receiving geometric conditions, differences in wavelength accuracy, the effect of the UV (ultraviolet light) component of the light source on the paper being measured, and effect of the glossiness of the paper. Other error factors include difference in the measurement environment, and difference is also thought to occur due to differences in the color of the material (backing) laid under samples when the samples are measured and differences in temperature and humidity.

Thus with a spectral color sensor, measurement error is included in the measured values thereof due to differences in model, environment and the like, and this measurement error become a hindrance, particularly in situations where highly accurate colorimetry is required. The above error is divided into horizontal scale error which is wavelength shift and vertical scale error which is spectral reflectance shift in the optical spectrum of spectral color sensor output. The concept of vertical scale error is shown in FIG. 15. In a wavelength λ in FIG. 15, the difference of a spectral reflectance targeted for correction (measured values 2) relative to a spectral reflectance (measured values 1) serving as a reference is vertical scale error (spectral reflectance shift) δ.

In a printing apparatus typified by a printer, color conversion look-up tables (hereinafter, LUTs) have conventionally been used in order to output desired colors. Color conversion LUTs include LUTs that are used in calibration for maintaining the color output by the printer in a given fixed state, and LUTs that are used in color matching typified by ICC profiles. In recent years, models have been available that have a spectral color sensor built into a printer engine. Such a printer prints color charts (hereinafter, patches) such as IT8.7/3 charts that comply with international standards, for example, measures the patches with a built-in spectral color sensor, and feeds the measured values back into generation of a color conversion LUT, prior to or during execution of a print job. It is thereby possible to perform color matching and print color stabilization of as internal processing of the printer, without using an external spectrophotometer or the like. Accordingly, in order to perform color matching and print color stabilization with high accuracy, the spectral color sensor built into the printer is required to perform high accuracy colorimetry, and correction of measurement error between sensor models such as mentioned above is desired.

Technologies such as the following have been proposed as techniques for correcting difference in sensor output for each model of spectral color sensor, that is, intra-model error (unit difference) and inter-model error (absolute value difference). First, there is technology that involves performing correction for fitting the tristimulus values XYZ of the sensor output to the measured values of a reference in a measuring device that employs an optical filter method, by converting the saturation, hue and brightness of the measured values thereof (for example, see Japanese Patent Laid-Open No. 05-026731). There is also technology that involves correcting wavelength shift (horizontal scale error) in a measuring device that employs a spectral method, by fitting the wavelengths of the optical spectrum thereof to the wavelengths of the optical spectrum of a reference (for example, see Japanese Patent Laid-Open No. 8-15134 and Japanese Patent Laid-Open No. 2006-214968).

However, conventional correction by converting saturation, hue and brightness could not be applied to an optical spectrum obtained with a measuring device that employs spectral method. Also, although vertical scale error (shift in spectral reflectance direction) and horizontal scale error (shift in wavelength direction) occur in an optical spectrum obtained with a measuring device that employs a spectral method due to differences in sensor model and environment, only horizontal scale error is corrected with the conventional optical spectrum wavelength correction. Accordingly, correcting an optical spectrum with high accuracy so as to be aligned with a reference was problematic.

### SUMMARY OF THE INVENTION

The present invention has been made in consideration of the above problems, and provides technology for correcting output error between models of spectrophotometer.

According to one aspect of the present invention, a color processing apparatus comprises: a first input unit configured to input a reference spectral reflectance obtained by measuring a patch image with a spectrophotometer serving as a reference unit; a second input unit configured to input a correction target spectral reflectance obtained by measuring the patch image with a spectrophotometer serving as a correction target unit; a correction coefficient generation unit configured to generate a correction coefficient between the correction target spectral reflectance and the reference spectral reflectance, for each wavelength; and a correction unit configured to correct, for each wavelength, the spectral reflectance measured by the correction target unit, using the correction coefficient.

According to another aspect of the present invention, a color processing method comprises the steps of: inputting a reference spectral reflectance obtained by measuring a patch image with a spectrophotometer serving as a reference unit; inputting a correction target spectral reflectance obtained by measuring the patch image with a spectrophotometer serving as a correction target unit; generating a correction coefficient between the correction target spectral reflectance and the reference spectral reflectance, for each wavelength; and correcting, for each wavelength, the spectral reflectance measured by the correction target unit, using the correction coefficient.

According to one aspect of the present invention, output error between models of spectrophotometer can be corrected.

Further features of the present invention will become apparent from the following description of exemplary embodiments (with reference to the attached drawings).

### BRIEF DESCRIPTION OF THE DRAWINGS

FIG. 1 is a block diagram showing an example configuration of a print system in a first embodiment.

FIG. 2 is a diagram showing spectral color sensors measuring patches.

FIG. 3 is a diagram showing the concept of colorimetric value calculation processing by a spectral color sensor.

FIG. 4 is a flowchart showing correction coefficient generation processing.

FIG. 5 is a diagram showing the correlation between optical spectra of a reference unit and a correction target unit.

FIGS. 6A-6C are diagrams showing example correlation curves of optical spectra.

FIG. 7 is a diagram showing the concept of sensor measured value correction.

FIG. 8 is a block diagram showing an example configuration of a print system in a second embodiment.

FIG. 9 is a diagram showing an example application UI.

FIG. 10 is a diagram showing the concept of vertical scale error and horizontal scale error between two optical spectra in a third embodiment.

FIG. 11 is a diagram showing an example of horizontal scale error detection.

FIG. 12 is a diagram showing an example correspondence table of pixel position and detection wavelength for a sensor light-receiving element.

FIG. 13 is a flowchart showing sensor model difference correction processing in a fourth embodiment.

FIGS. 14A-14C are diagrams showing the spectral reflectance of patches for horizontal scale calibration.

FIG. 15 is a diagram showing the concept of vertical scale error between two optical spectra.

FIGS. 16A-16C are diagrams illustrating correlation curve interpolation processing.

FIGS. 17A-17B are block diagrams showing different example configurations of the print system in the first embodiment.

### DESCRIPTION OF THE EMBODIMENTS

Hereinafter, embodiments of the present invention are described in detail with reference to the drawings. Note that the following embodiments are not intended to limit the claims of the present invention, and not all combinations of features described in the embodiments are essential to the invention.

### First Embodiment

In the present embodiment, an example is described in which intra-model difference between a plurality of spectrum color sensors (unit difference) built into an electrophotographic printer is corrected. In the present embodiment, a given one of the plurality of spectral color sensors built into the printer is used as a reference unit, and the optical spectra of the other spectral color sensors serving as correction target units are fitted to the optical spectrum of the reference unit. Specifically first, the correlation between the vertical scales of optical spectrum output, being colorimetric values, of the reference unit and a spectral color sensor is computed, and a correlation curve representing the correlation is calculated. The optical spectrum output is then corrected using correction coefficients representing this correlation curve.

Printer Configuration

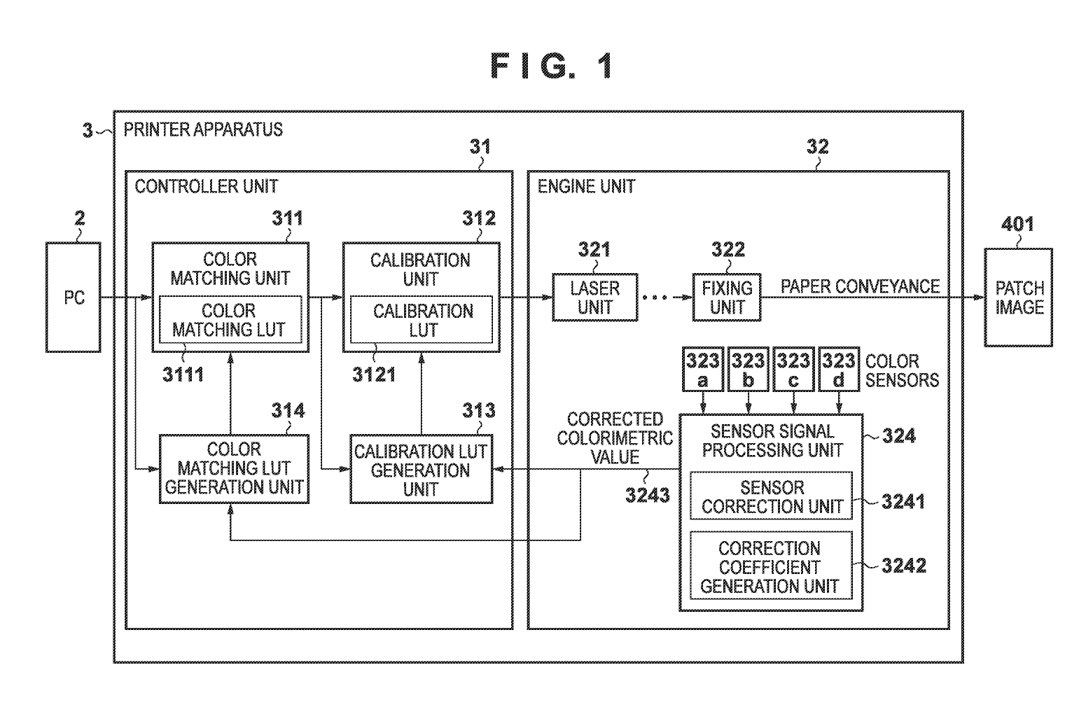

FIG. 1 is a block diagram showing an example configuration of a print system in the present embodiment. In the print system of the present embodiment as shown in FIG. 1, a PC 2 and a printer apparatus 3 are connected, and an image is printed on a medium as a result of image data generated by the PC 2 being sent to the printer apparatus 3.

The functional parts of the printer apparatus 3 are roughly divided between a controller unit 31 and an engine unit 32. The controller unit 31 has a color matching unit 311, a calibration unit 312, a calibration LUT generation unit 313, and a color matching LUT generation unit 314. Note that although there are various functional parts relating to other image processing in the controller unit 31, description regarding configuration that is not directly related to the present embodiment is omitted here. The color matching unit 311 performs color adjustment that uses a color matching LUT 3111 typified by an ICC profile. The color matching LUT generation unit 314 generates the color matching LUT 3111 using after-mentioned colorimetric values 3243. The calibration unit 312 performs image correction (calibration) for keeping the printing state constant, using a calibration LUT 3121 as typified by a CMYK one-dimensional LUT. The calibration LUT generation unit 313 generates the calibration LUT 3121, using colorimetric values 3243 from the engine unit 32. In the present embodiment, the color matching LUT 3111 and the calibration LUT 3121 function as color conversion LUTs.

On the other hand, the engine unit 32 has a laser unit 321, a fixing unit 322, spectral color sensors 323a, 323b, 323c and 323d, and a sensor signal processing unit 324. The spectral color sensors 323a, 323b, 323c and 323d are spectrophotometers that receive reflected light from a sample and output a spectral reflectance indicating the reflectance for each wavelength. Note that although the engine unit 32 has various other functional parts for forming images on a medium such as paper, description regarding configuration that is not directly related to the present embodiment is omitted here. Here, a print image generation process in the engine unit 32 is described. First, a photosensitive drum that is not shown is charged by a charging roller that is not shown. The laser unit 321 then forms an electrostatic latent image on the photosensitive drum by irradiating (exposing) the charged photosensitive drum with laser light based on calibration data sent from the calibration unit 312. Next, the electrostatic latent image on the photosensitive drum is developed with a developing device that is not shown, and a toner image is formed. Next, the toner image on the photosensitive drum is transferred to a transfer belt that is not shown, and the toner image on the transfer belt is transferred to a medium such as recording paper. Finally, the toner is then fused and fixed to the medium as a result of heat and pressure being applied in the fixing unit 322 to the medium that has been conveyed thereto. As a result of the above process, an image (patch image 401, etc.) such as a character or a patch can be printed on a medium such as recording paper.

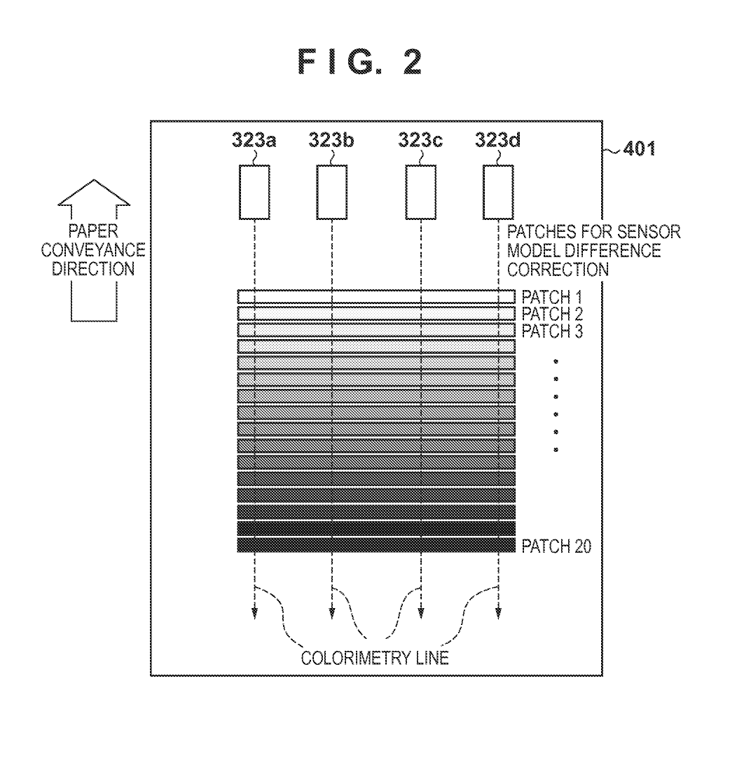

Next, colorimetry processing using the spectral color sensors 323a, 323b, 323c and 323d built into the engine unit 32 is described. The four spectral color sensors 323a, 323b, 323c and 323d are installed on the conveyance path from the fixing unit 322 to the discharge port, and measure patches on the conveyed medium (patch image 401). The four spectral color sensors 323a, 323b, 323c and 323d are, as shown in FIG. 2, assumed to be installed so as to be horizontally aligned (direction parallel to the sheet surface) orthogonal to the medium conveyance direction with a prescribed interval therebetween. Data measured by the spectral color sensors 323a, 323b, 323c and 323d is sent to the sensor signal processing unit 324. The sensor signal processing unit 324 converts the measured data into colorimetric values 3243 (for example, spectrum data, tristimulus values XYZ, CIE L*a*b*, etc.) using after-mentioned processing. Also, in a sensor correction unit 3241, intra-model difference (sensor unit difference) is corrected using after-mentioned sensor model difference correction processing. Colorimetric values 3243 that have undergone unit difference correction using this correction processing are transmitted to the calibration LUT generation unit 313 and the color matching LUT generation unit 314. A correction coefficient generation unit 3242 generates correction coefficients required in order to perform sensor model difference correction processing. Correction coefficients are generated for sensor model difference correction, based on colorimetric values obtained by performing colorimetry with the spectral color sensors 323a, 323b, 323c and 323d on a patch image 401 for use in sensor model difference correction such as shown in FIG. 2.

Prior to or during execution of a print job, the printer apparatus 3 of the present embodiment outputs patches for calibration on a medium (recording paper), and measures these patches with the built-in spectral color sensors 323a, 323b, 323c and 323d. The color reproducibility of the printer apparatus 3 is kept constant by creating and updating the calibration LUT 3121 based on these measured values. Similarly, with regard to the color matching LUT 3111, patches for color matching are output on a medium, and the LUT is created or updating based on values obtained by measuring these patches with the built-in spectral color sensors 323a, 323b, 323c and 323d. Differences in tint and the like between printer apparatuses are thereby absorbed.

Note that as a result of the printer apparatus 3 being equipped with the four spectral color sensors 323a, 323b, 323c and 323d, different positions on the formed image can be measured at the one time. Shortening the measurement time and cutting back on the number of sheets of patch images output from the printer apparatus 3 can thereby be achieved. Hereinafter, these four sensors are collectively referred to as spectral color sensors 323. Also, the timing at which the calibration LUT 3121 and the color matching LUT 3111 are updated can be determined based on preset configurations. For example, these LUTs can be set to be updated whenever a print job is received.

Colorimetry by Spectral Color Sensors

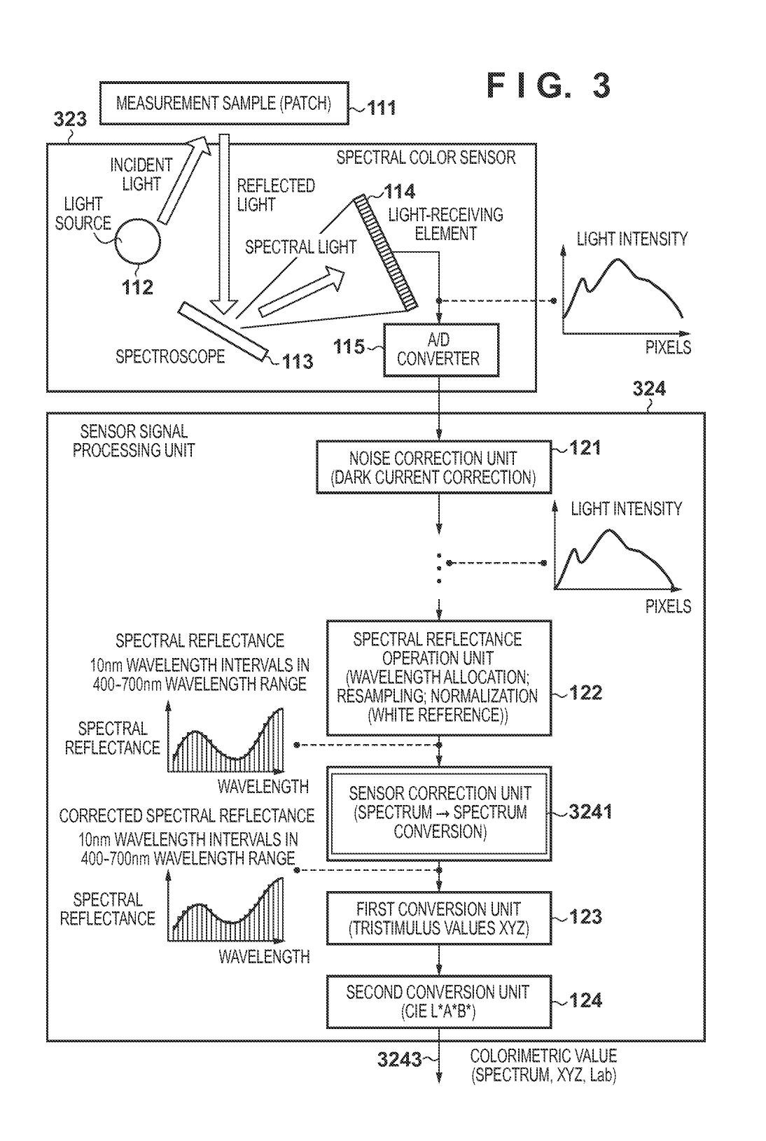

Hereinafter, measured value calculation processing by the spectral color sensors 323 and the sensor signal processing unit 324 is described using FIG. 3.

The spectral color sensors 323 are mainly constituted by a light source 112, a spectroscope 113, a light-receiving element 114, and an A/D converter 115. Although there are various other functional parts, description regarding configuration that is not directly related to the present embodiment is omitted here. In the spectral color sensors 323, first, the measurement sample 111 is irradiated with light emitted from the light source 112. Next, light from the measurement sample 111 is reflected back to the spectral color sensors 323, and broken down into the light of each wavelength by the spectroscope 113, which is a diffraction grating spectroscope or the like. Next, the light broken down into each wavelength is converted into an electrical signal by the light-receiving element 114, which is a CMOS line sensor or the like. Next, an analog electrical signal output from the light-receiving element 114 is digitized with the A/D converter 115, and sent to the sensor signal processing unit 324. Only one sensor signal processing unit 324 is illustrated in FIG. 3. However, there may be as many sensor signal processing units 324 as there are spectral color sensors.

In the sensor signal processing unit 324, noise correction processing such as dark current correction is performed by the noise correction unit 121 on the digital signal from the spectral color sensor 323. Next, the spectral reflectance operation unit 122 calculates the spectral reflectance from the noise-corrected data. Spectral reflectance is calculated through the following processing. First, wavelength allocation processing for allocating wavelengths to pixel data, and then normalization processing for division by white reference data are performed. Further, resampling processing for thinning out the pixel data and converting the resultant data to comply with the international standards (for example, 10 nm wavelength intervals in 400-700 nm wavelength range) for spectral color sensor output is then performed. Since the processing for computing these spectral reflectances is known, a detailed description is omitted here.

The calculated spectral reflectance undergoes after-mentioned sensor model difference correction by the sensor correction unit 3241. Be aware that that sensor model correction in the present embodiment is implemented on spectral reflectance after conversion, rather than correcting the output of the light-receiving element itself. The spectral reflectance corrected in the sensor correction unit 3241 is converted into tristimulus values XYZ or CIE L*a*b* in first and second conversion units 123 and 124, and output as colorimetric values 3243.

Correction of Intra-Model Difference between Sensors

Hereinafter, processing for correcting intra-model difference between sensors in the present embodiment (sensor unit difference) is described in detail. The present embodiment aims to eliminate unit difference between the four spectral color sensors 323a, 323b, 323c and 323d. Thus, an example is shown in which the spectral color sensor 323a out of the four sensors is taken as a reference unit, the other three spectral color sensors 323b, 323c and 323d are taken as correction target units, and the optical spectra of the correction target units are fitted to the optical spectrum of the reference unit. Note that in addition to the example in which the characteristics of a plurality of sensors serving as correction target units are aligned with a single sensor, a configuration may be adopted in which, for example, the average value of the colorimetric values of all the sensors is taken as a reference value, and each sensor is aligned with this reference value. Also, the present embodiment is not limited to the example in which a sensor incorporated into the printer apparatus is taken as the reference unit, and a configuration may be adopted in which a sensor of the same model managed externally to the printer is taken as a reference unit (master unit).

Processing for correcting intra-model difference between sensors in the present embodiment is divided into a process of generating correction coefficients required in order to correct unit difference and a process of correcting colorimetric values using the generated correction coefficients. Hereinafter, the respective processes are described in detail.

Correction Coefficient Generation

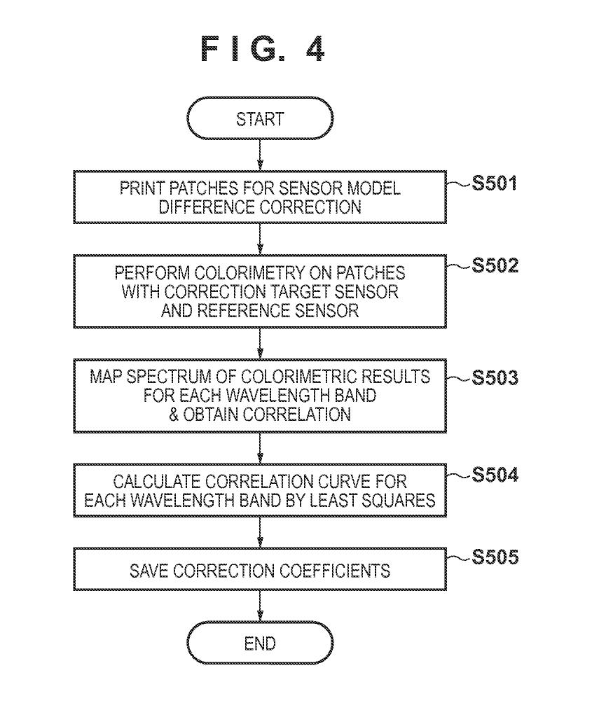

First, correction coefficient generation processing is described using the flowchart of FIG. 4. This processing involves measuring the same patch image 401, as shown in FIG. 2, with sensors with respect to which it is desired to eliminate sensor model difference, and determining correction coefficients by computing the correlation between the optical spectra (spectral reflectances) of the measured values thereof.

First, in S501, the printer apparatus 3 prints the patch image 401 for correction of intra-model difference between sensors. This patch image 401 differs from the above-mentioned patch images for calibration and for color matching, and is only for intra-model sensor correction. Here a plurality of monochrome black patches (patches 1-20) that respectively differ in gradation, that is, patches consisting of N steps of monochrome black 0 to 100% are assumed to be used as the patch image 401. This is because use of monochrome black patches (gray patches) having comparatively flat spectral characteristics is considered appropriate, in order to compute the correlation between the vertical scales of the output (optical spectra) of a reference unit and a correction target unit in an after-mentioned S503.

Next, in S502, the four spectral color sensors 323 measure the patches 1-20 for correction of intra-model difference between sensors that were printed at S501 and have been conveyed to a colorimetry position of the spectral color sensors 323, as shown in FIG. 2. That is, the single reference unit 323a and the three correction target units 323b, 323c and 323d measure the same patches. A reference spectral reflectance is thereby obtained with the reference unit 323a as a first input unit, and correction target spectral reflectances are obtained with the correction target units 323b, 323c and 323d as second input units. The obtained measurement results are used in processing (S503-S505) for creating the correction coefficients for unit difference correction in the correction coefficient generation unit 3242 of the sensor signal processing unit 324.

At S503 the correction coefficient generation unit 3242 computes the correlation between the reference unit and the correction target units for each wavelength, from the correction target spectral reflectances, being the measured values of the correction target units 323b, 323c and 323d, and the reference spectral reflectance, being the measured value of the reference unit 323a, that are obtained at S502. In order to compute this correlation for each correction target unit, in the present embodiment, a total of three correlations, that is, between the reference unit 323a and the correction target unit 323b, between the reference unit 323a and the correction target unit 323c, and between the reference unit 323a and correction target unit 323d, will be computed. Hereinafter, the reference unit 323a is notated simply as the reference unit, and the correction target units 323b, 323c and 323d are notated collectively as the correction target units.

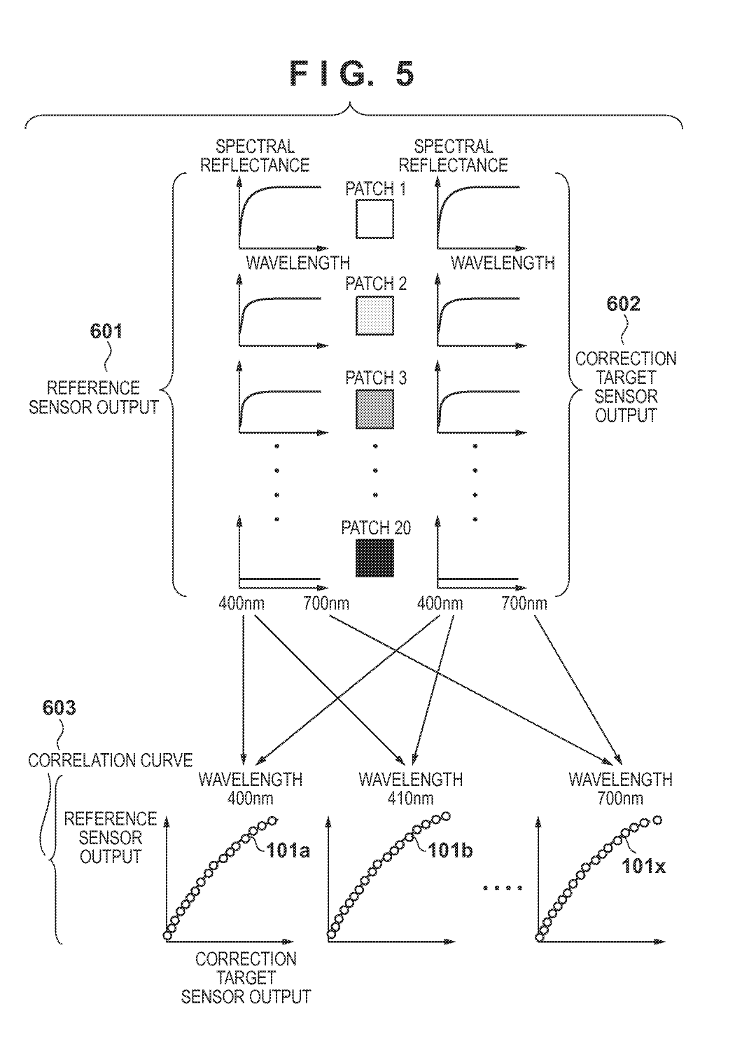

Here, correlation between the optical spectra of the reference unit and the correction target units is described in detail using FIG. 5. In FIG. 5, the spectral reflectance of each patch that is a value measured by the reference unit is obtained as a reference spectral reflectance, that is, a reference sensor output 601, and the spectral reflectance of each patch that is a value measured by the correction target unit is obtained as a correction target spectral reflectance, that is, a correction target sensor output 602. A correlation graph 603 for each wavelength is then obtained, by mapping the measurement results of the patches 1-20 for each wavelength on a graph showing the correction target sensor output 602 on the horizontal axis and the reference sensor output 601 on the vertical axis. For example, because 20 patches worth of inter-sensor correlation relationships are obtained in the case where all 20 patches are measured with three correction target units, 20 plots are mapped for each correction target unit, and the same number of correlation graphs 603 as the number of sampled wavelengths are further obtained. Note that as for the wavelengths for computing the correlation, in the case of a measuring device that outputs at 10 nm intervals in a 380-730 nm wavelength range, which is standard for spectrophotometer output, correlation is desirably computed for each 10 nm wavelength.

Next, in S504, function fitting by least-squares is performed on the mapping on each correlation graph 603 obtained at S503, and a correlation curve representing the correlation relationship between the reference unit and the correction target unit is calculated. A multi-order fitted curve such as a quadratic function, for example, is used for this correlation curve.

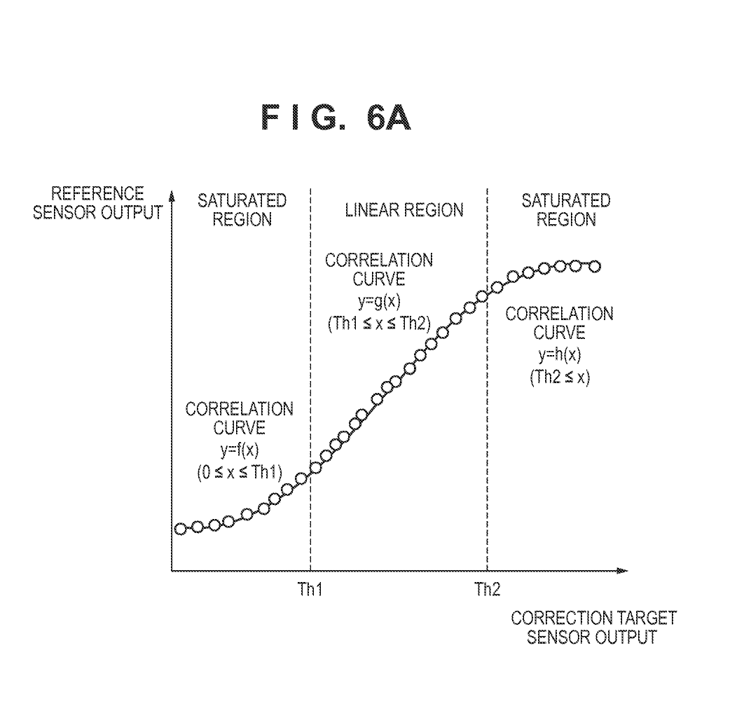

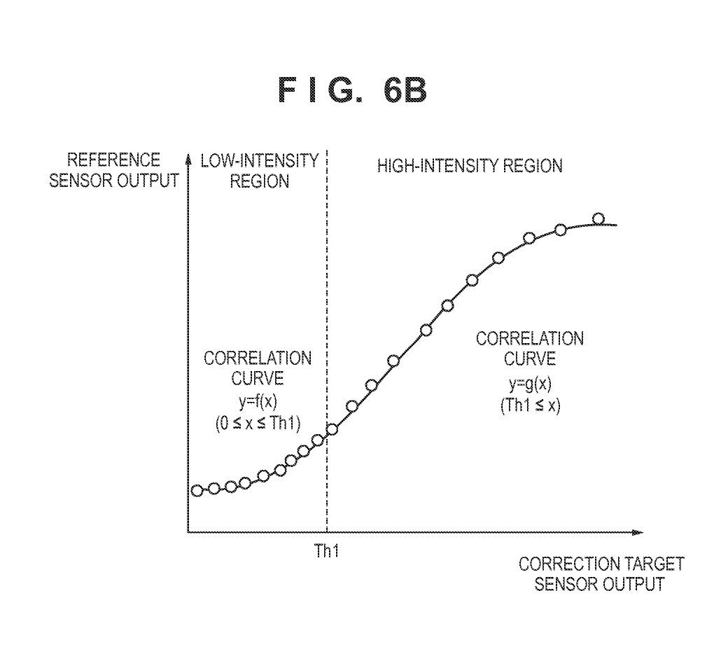

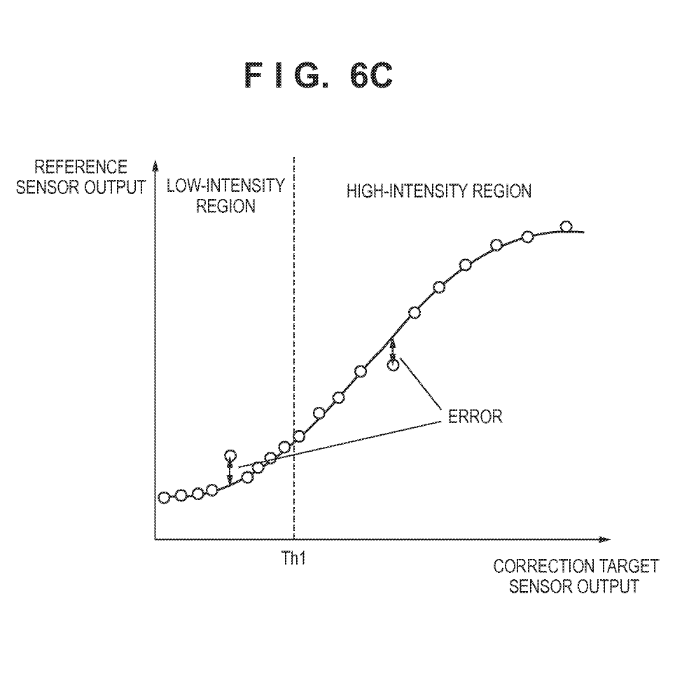

Note that depending on the combination of sensor models for which correlation is computed, the correlation curve could conceivably be divided into a linear region where the slope of the correlation curve is linear and a saturated region that is regarded as being saturated, as shown in FIGS. 6A-C. In such a case, processing can be added that, for instance, involves the correlation curve being segmented and represented as a combination of a plurality of functions, or involves providing thresholds and stabilizing the values at or below (or at or above) a given value.

Generally in a relatively black region (low-intensity region), error has a greater effect on accuracy (color difference) as compared with a relatively white region (high-intensity region). Thus, in order to reduce error as much as possible, it is desirable to segment the correlation curve and, with regard to the relatively black region (low-intensity region), to represent the correlation curve with a low-dimensional approximation function (for example, linear function, etc.) (FIG. 6B). Error reduction between the correlation curve and the original correlation graph and improvement in robustness to noise can thereby be expected.

Also, when a correlation curve is derived for each of the segmented regions, discontinuous points may exist on the boundary lines between the regions. Accordingly, in order to ensure the continuity of the correlation curves at the boundary lines between the regions, the following interpolation processing using weight functions may be introduced. Note that linear interpolation may also be used in addition to the following technique.

Interpolation of Discontinuous Points Arising from Correlation Curve Segmentation

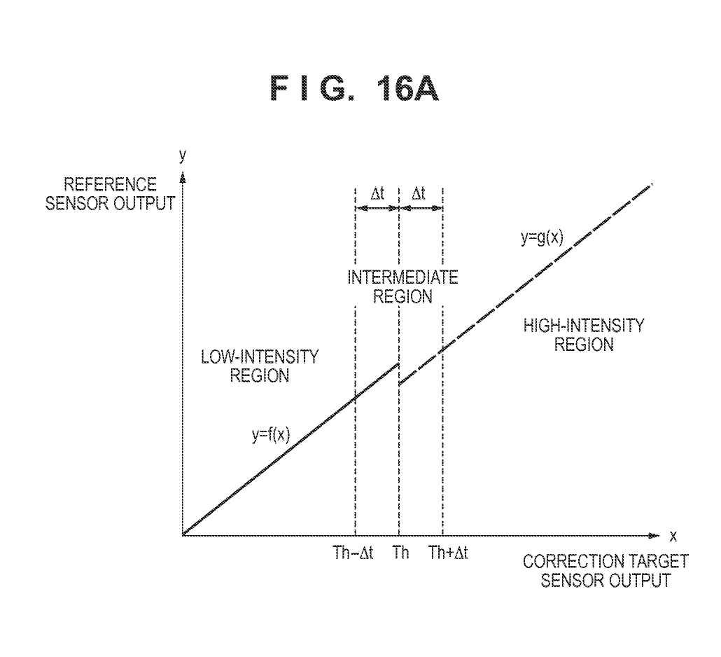

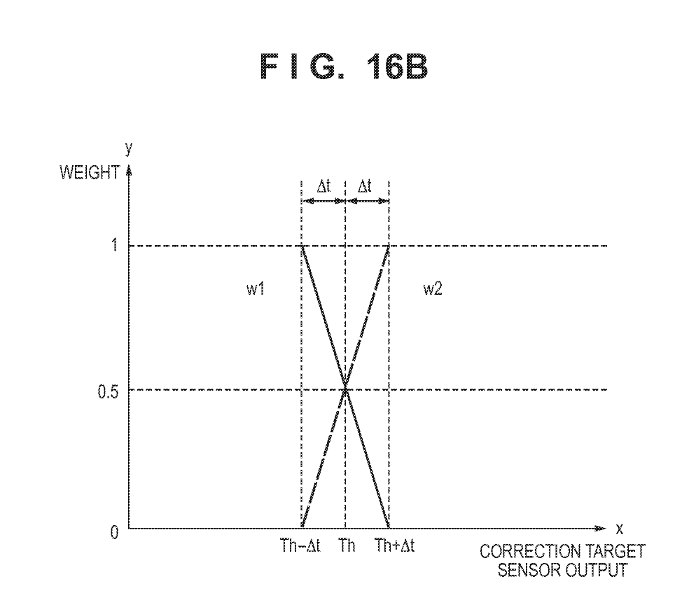

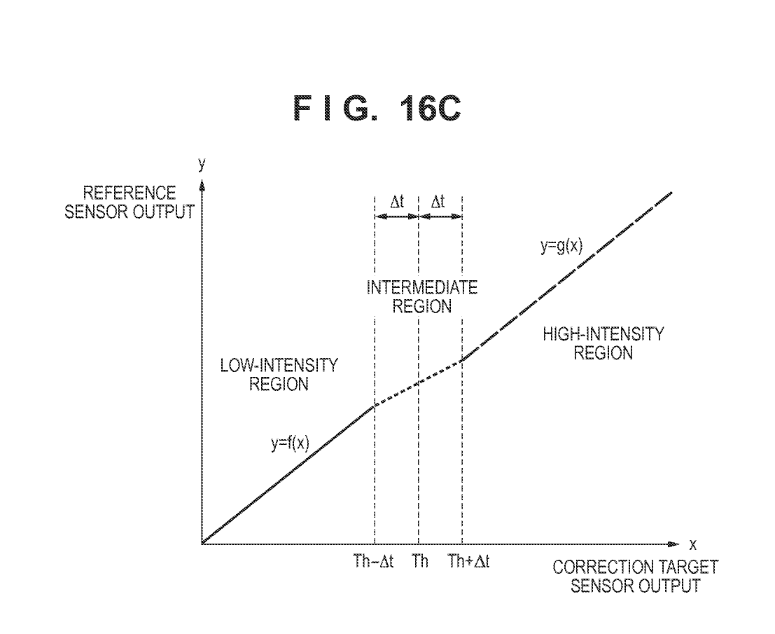

First, as shown in FIG. 16A, the correlation curve in the low-intensity region is defined as y=f(x), the correlation curve in the high-intensity region is defined as y=g(x), and the segment of thresholds Th±Δt is defined an intermediate region.

Next, weight functions w1 and w2 as shown in FIG. 16B are defined:

y=−(1/(2Δt))x+(1+(Th/Δt))/2 w1:

y=(1/(2Δt))x+(1−(Th/Δt))/2 w2:

(Th−Δ<x<Th+Δt)

Next, the correlation curve y=f(x) in the low-intensity region and the correlation curve y=g(x) in the high-intensity region are applied respectively to the weight w1 and the weight w2, and added together.

y=w1×f(x)+w2×g(x)

The above results in a correction equation for the intermediate region where the correlation curve of the low-intensity region and the correlation curve of the high-intensity region are combined equally being obtained. The discontinuous points at the boundary line between the regions can thus be removed, as shown in FIG. 16C.

Also, in the case where spectral color sensors that function to change the storage time of the light-receiving element (for example, CMOS sensor) according to the brightness of the patch undergoing colorimetry are used, a correlation curve is provided for each storage time.

Next, in S505, coefficients representing the correlation curves obtained at S504 are saved as correction coefficients to a memory (not shown) in the sensor correction unit 3241, for example. For example, assume that the reference spectral reflectance, being the reference sensor output 601, is represented as Rstd, the correction target spectral reflectance, being the correction target sensor output 602, is represented as Rtrg, and the correlation curves are represented as quadratic functions expressed by equation (1) below. In this case, the coefficients a, b, and c of each item can be saved as correction coefficients. Note that in the following equation, the notation “Â2” indicates the “square of A”.

Rstd=a·Rtrĝ2+b·Rtrg+c (1)

In the present embodiment, values such as the following are held for each correction target unit, so that there will be a correction coefficient for each wavelength. For example, when the correlation curves for each wavelength at 10 nm intervals from 400 nm to 700 nm are respectively given as 101a, 101b, . . . , 101x, these correlation curves are expressed as in the following equations. That is, the coefficients (A1, B1, C1 to A31, B31, C31) of each item will be provided as correction coefficients.

$$Correlation 101 a \text{:} Rstd = A 1 \cdot Rtrg \hat{} 2 + B 1 \cdot Rtrg + C 1$$

$$Correlation 101 b \text{:} Rstd = A 2 \cdot Rtrg \hat{} 2 + B 2 \cdot Rtrg + C 2$$

$$⋮$$

$$⋮$$

$$Correlation 101 x \text{:} Rstd = A 31 \cdot Rtrg \hat{} 2 + B 31 \cdot Rtrg + C 31$$

Note that rather than coefficients such as the above, LUTs representing the correlation curves may be saved as correction coefficients. Also, correction coefficients may be calculated in advance, before incorporating the spectral color sensors 323 into the printer apparatus 3. In this case, correlation curves representing correlation with the reference unit output can be calculated in advance, and obtained correction coefficients can be written into the sensor signal processing unit 324.

If a correction curve is segmented into two or more regions, as shown in FIGS. 6A-6C and 16A-16C, calculated coefficients of correlation curves for each region can be saved as correction coefficients.

Measured Value Correction

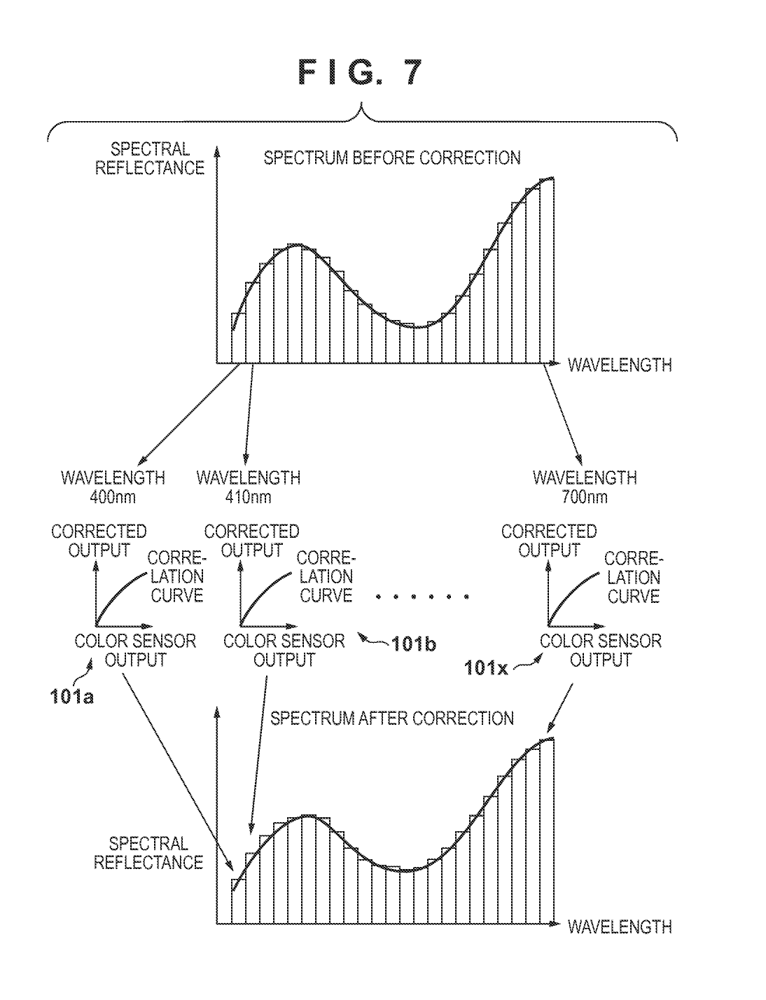

Next, processing for correcting the measured values of the spectral color sensors using the generated correction coefficients is described. In the present embodiment as mentioned above, patches for calibration LUT generation and for color matching LUT generation are measured using the four spectral color sensors 323, and these measured values are corrected using the correction coefficients saved at S505. FIG. 7 shows the concept of this correction. As shown in FIG. 7, the measured values of the correction target units are corrected for each wavelength, based on the correlation curve 101 for each correction target unit obtained at S504. For example, if, in the case where the correlation curve of a certain wavelength is represented as a quadratic function of the above-mentioned equation (1), the correction coefficients a, b and c are known values, the reference unit output Rstd can be derived by substituting the correction target unit output Rtrg into equation (1). Performing the above operation for all wavelength regions enables the correction target unit output to be converted so as to be equivalent to the reference unit output. Note that since the spectral color sensor 323a is used as the reference unit here, the output value of the spectral color sensor 323a is not corrected.

In the present embodiment, sampling points (for example, points in FIG. 6A) are arranged equidistantly. However, in order to further improve accuracy, sampling points may be arranged as follows. As already mentioned, generally, measurement error tend to arise in the relatively black region (region in which the sensor output value is small) as compared with the relatively white region (region in which the sensor output value is large). Therefore, providing more sampling points in the relatively black region than in the relatively white region enables error to be efficiently reduced (FIG. 6B). For example, error can be reduced by adopting a configuration in which more smaller reflectances than larger reflectances are included in the groups of measured values (reflectances) measured for the respective patches, for at least one wavelength or all the wavelengths included in the reference spectral reflectance or the correction target spectral reflectances. As a specific example, error can be reduced in the case where the distribution of a prescribed number of larger values is greater than the distribution of a prescribed number of smaller values, among the measured values (reflectances) measured for the respective patches. Providing more sampling points in the relatively black region than the relatively white region can be realized by increasing the number of lower density patches, as well as disregarding the measured values for higher density patches among the reference spectral reflectance and the correction target spectral reflectances.

In the present embodiment, a detection unit that detects measurement failure with respect to at least one of the reference spectral reflectance and the correction target spectral reflectance may be provided. Methods for detecting measurement failure include the following:
(1) After calculating a correlation curve, the error between the correlation curve and each sampling point is computed. Measurement failure is detected if the error for a given sampling point is greater than or equal to a threshold. (FIG. 6C)
(2) A wavelength-specific referential spectral reflectance for each patch is stored, and the difference between this referential spectral reflectance and at least one of the reference spectral reflectance and the correction target spectral reflectance is calculated. Measurement failure is detected if this difference is greater than or equal to a threshold.
(3) An upper limit and a lower limit are provided for each correction coefficient, and measurement failure is detected if a correction coefficient exceeding the range defined by the upper and lower limits is acquired.
(4) Generally spectral reflectance changes continuously and does not tend to change rapidly. Therefore, it is often the case that measurement has failed if the difference in spectral reflectance between adjacent wavelengths is very large in at least one of the reference spectral reflectance and the correction target spectral reflectance. Therefore, measurement failure is detected if the difference in spectral reflectance for adjacent wavelengths is greater than or equal to a threshold.

Data for a wavelength with respect to which measurement failure was detected is not used to generate a correction coefficient. In this case, measurement and correction coefficient generation may be performed again. Also, the correction coefficient for a wavelength with respect to which measurement failure is detected may be generated by interpolation, using the correction coefficients for other wavelengths. Alternatively, a configuration may be adopted in which the data for a patch with respect to which measurement failure is detected is not used to generate correction coefficients.

According to the present embodiment as described above, the measured values of a plurality of spectral color sensors built into a printer apparatus are corrected such that the unit difference between the sensors decreases. Accordingly, the accuracy of the calibration LUT and color matching LUT created using these measured values can be increased, enabling the color reproducibility of the printer to be stabilized and the accuracy of color matching to be increased.

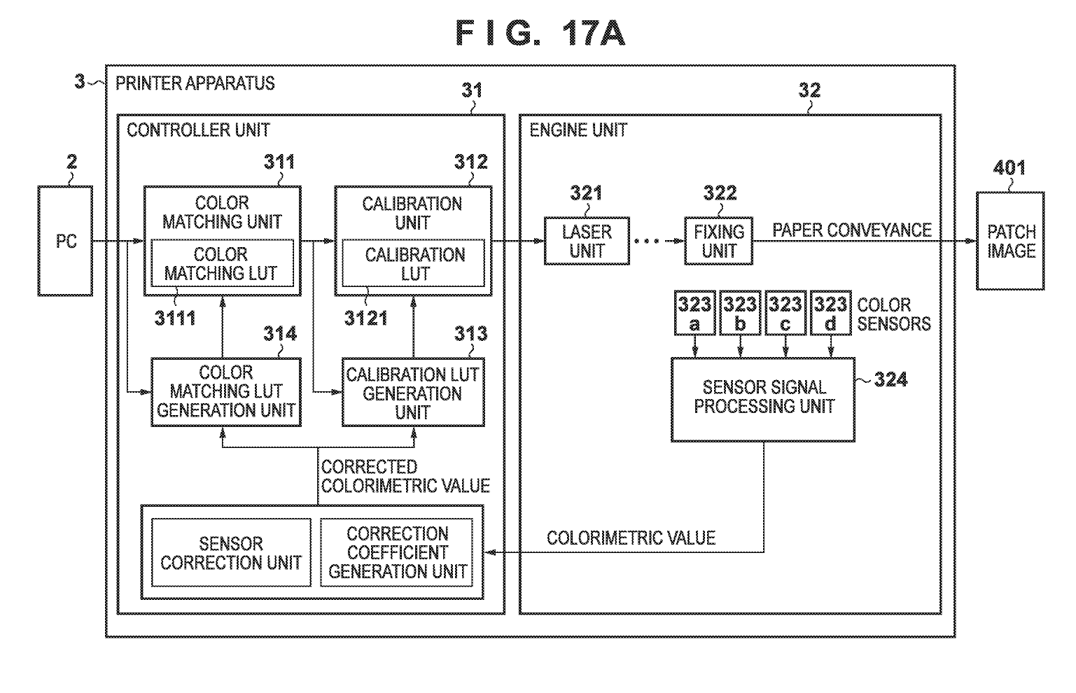

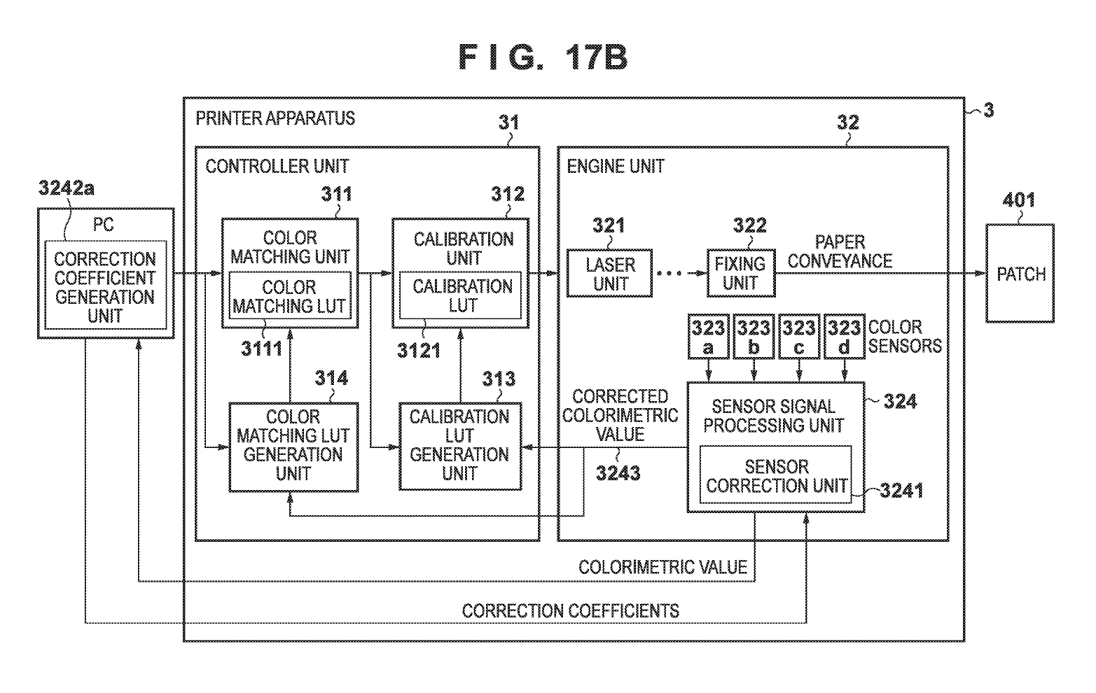

Note that although an example was shown in which processing for generating correction coefficients and processing for correcting measured values are performed in the sensor signal processing unit 324 of the engine unit 32 in the printer apparatus 3 of the present embodiment, the present invention is not limited to this example. For example, a configuration may be adopted in which this processing is performed in the printer controller unit 31 as shown in FIG. 17A, or a configuration may be adopted in which this processing is performed using application software on the PC 2 as shown in FIG. 17B.

### Second Embodiment

Hereinafter, the second embodiment according to the present invention is described. In the above-mentioned first embodiment, the case was described where correction of the unit difference between four spectral color sensors 323 built into the printer apparatus 3 (vertical scale correction of spectral reflectance) was performed on the basis of the optical spectrum of the single spectral color sensor 323a. In contrast, in the second embodiment, an example is shown in which an optical spectrum obtained from the measured values of a spectral color sensor built into a printer apparatus is fitted to an optical spectrum obtained from the measured values of a different model spectral color sensor that is external to the printer apparatus. That is, an example is shown in which a spectral color sensor built into a printer apparatus serves as a correction target unit, and the optical spectrum thereof is fitted to a master unit that is external to the printer apparatus. Thus in the second embodiment, inter-model difference between spectral color sensors (absolute value difference) is corrected.

Thus in the second embodiment, the main difference from the above-mentioned first embodiment lies in the portion relating to the optical spectrum serving as a reference. Accordingly in the second embodiment, the same numerals are given with regard to configuration that is similar to the above-mentioned first embodiment, and description thereof is omitted.

Printer Configuration

FIG. 8 is a block diagram showing an example configuration of a print system in the second embodiment. The print system of the second embodiment as shown in FIG. 8 is characterized by there being a single spectral color sensor 323 and further by an external reference colorimetry device 4 being externally connected, in comparison to the configuration shown in FIG. 1 in the above-mentioned first embodiment. That is, a patch image 401 generated in the printer apparatus 3 undergoes colorimetry in the external reference colorimetry device 4, and the colorimetric results are input to the PC 2. Correction coefficients for spectral color sensor 323 are generated by running application software (hereinafter, simply referred to as an application) on the PC 2. The generated correction coefficients are written to the sensor signal processing unit 324 of the engine unit 32 in the printer apparatus 3.

Correction of Inter-Model Difference Between Sensors

Hereinafter, processing for correcting inter-model difference between sensors (absolute value difference) in the present embodiment is described in detail. In the second embodiment as mentioned above, an example is shown in which the optical spectrum of a correction target unit is fitted to the optical spectrum of a reference unit, with the spectral color sensor 323 built into the printer apparatus 3 serving as the correction target unit and the external reference colorimetry device 4 serving as the reference unit. The processing for correcting inter-model difference between sensors in the second embodiment is also divided into a process of generating correction coefficients and a process of correcting measured values using these correction coefficients, with the process of correcting measured values being similar to the first embodiment. Although the processing for generating correction coefficients in the second embodiment is, similarly to the above-mentioned first embodiment, based on the flowchart of FIG. 4, the specific operations in the steps differ.

First, in S501, the printer apparatus 3 prints the patch image 401 for correction of inter-model difference between sensors. Next, in S502, the spectral color sensor 323 measures the patches 1-20 for correction of inter-model difference between sensors that were printed at S501 and have been conveyed to the colorimetry position of the spectral color sensor 323, as shown in FIG. 2. In the second embodiment, the patches 1-20 for correction of inter-model difference between sensors in the patch image 401 output from the printer apparatus 3 are further measured with the external reference colorimetry device 4, which is separate from the printer apparatus 3. Note that measurement of patches by the external reference colorimetry device 4 is, to be specific, performed by a spectral color sensor provided in the colorimetry device 4. The patches 1-20 measured with the external reference colorimetry device 4 are the same as the patches measured with the spectral color sensor 323 built into the printer apparatus 3.

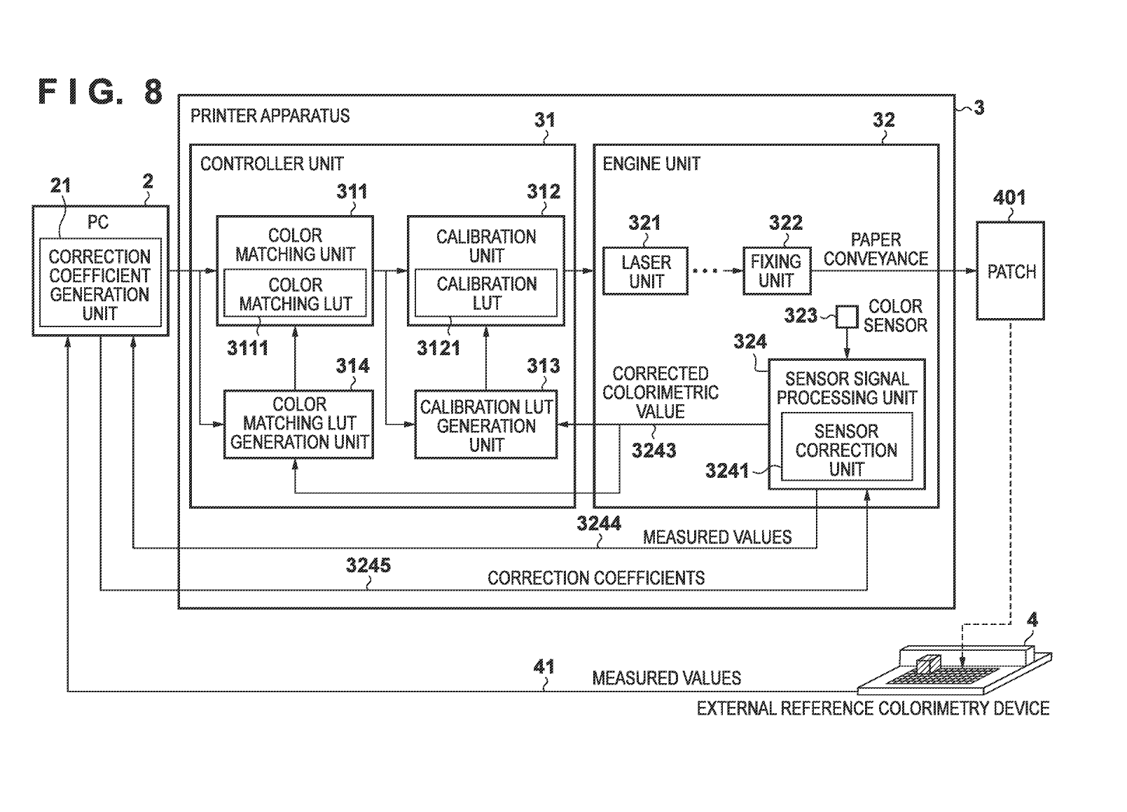

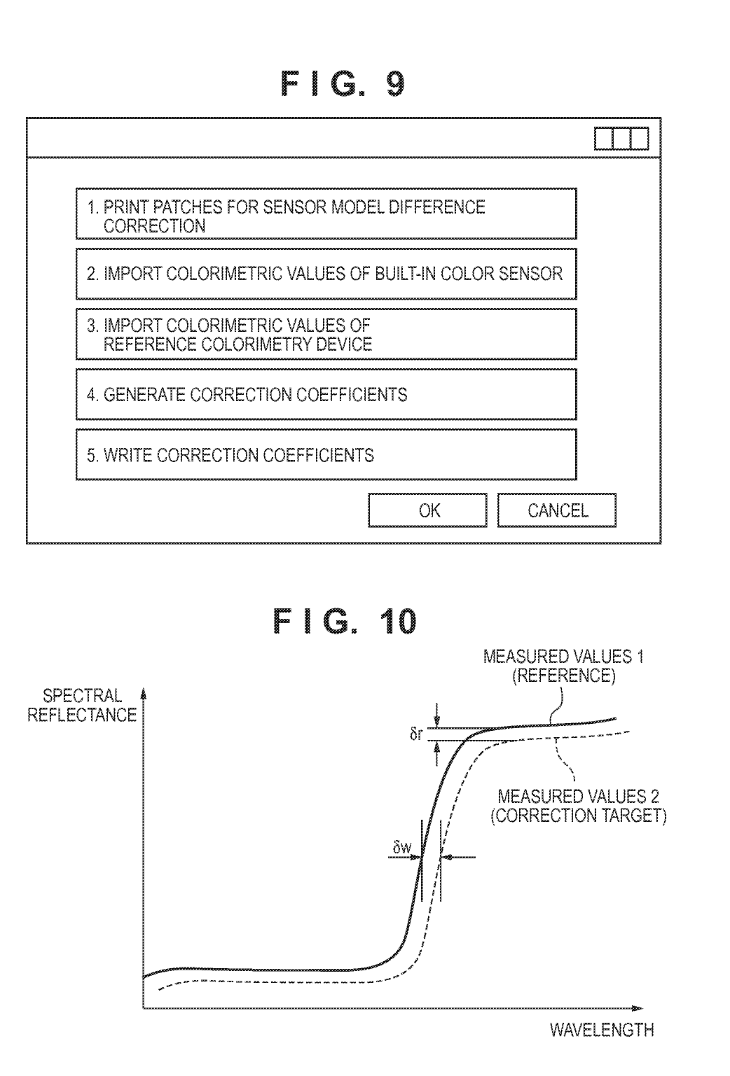

The results of measuring the patches 1-20 by the spectral color sensor 323 built into the printer apparatus 3 are then transmitted to the PC 2 via the sensor signal processing unit 324 as measured values 3244. Also, the results of measuring of the patches 1-20 by the external reference colorimetry device 4 are transmitted to the PC 2 as measured values 41. An application for importing these measured values is provided in the PC 2, and this application operates as a correction coefficient generation unit 21 in the PC 2 in the second embodiment. Here, FIG. 9 shows an example UI of this application, that is, an example UI of the correction coefficient generation unit 21. According to FIG. 9, it can be seen that respective instruction buttons are displayed for instructing printing of patches for sensor model difference correction, importing the measured values 3244 of the spectral color sensor built into the printer, importing the measured values of the external reference colorimetry device 4, generating correction coefficients 3245, and writing the correction coefficients 3245. That is, it can be seen that a series of operations from printing of patches to writing of correction coefficients in the processing for correcting inter-model difference between sensors is performed by the application 21.

Next, in S503, the correction coefficient generation unit 21 computes the correlation for each wavelength of the optical spectra, from the optical spectrum given by the measured values of the built-in spectral color sensor 323 and the optical spectrum given by the measured values of the external reference colorimetry device 4 obtained at S502. In S504, function fitting by least squares is performed on each correlation graph obtained at S503, and correlation curves are calculated. Note that since the details of the processing of S503 and S504 are similar to the above-mentioned first embodiment, a detailed description thereof is omitted.

Next, in S505, the application 21 calculates correction coefficients 3245 representing the correlation curves obtained at S504, and writes the correction coefficients 3245 to the sensor correction unit 3241. Correction coefficients for correcting inter-model difference between the built-in spectral color sensor 323 and the external reference colorimetry device 4 are thereby saved in the sensor correction unit 3241.

In the second embodiment, similarly to the first embodiment, the measured values of the built-in spectral color sensor 323 are corrected using the correction coefficients generated as described above. That is, the values obtained by measuring the patches for calibration LUT generation and for color matching LUT generation with the spectral color sensor 323 are corrected using the correction coefficients saved at S505.

According to the second embodiment as described above, the measured values of the spectral color sensor 323 built into the printer apparatus 3 are corrected, such that the inter-model difference (absolute value difference) between the built-in spectral color sensor 323 and the external reference colorimetry device 4 decreases. Accordingly, since measured values equivalent to the external reference colorimetry device 4 are obtained with the built-in spectral color sensor 323, it is possible, when creating the color matching LUT using the built-in spectral color sensor 323, for example, to create a LUT that is equivalent to the case where the LUT is created using the external reference colorimetry device 4.

Note that although an example is shown in the present embodiment in which correction coefficients are created with the application 21 in the PC 2, this processing can also be performed in the controller unit 31 or the engine unit 32 internal to the printer. Also, before incorporating the spectral color sensor 323 into the printer apparatus 3, the optical spectrum thereof may be aligned with the sensor serving as a reference for inter-model difference correction (external reference colorimetry device 4). It is also possible to integrate a plurality of spectral color sensors into the printer apparatus 3, and to align the respective spectra to a master device (external reference colorimetry device 4) external to the printer apparatus with all of these sensors as the correction target unit.

### Third Embodiment

Hereinafter, the third embodiment according to the present invention is described. In the above-mentioned first and second embodiment, an example was shown in which vertical scale error of spectral reflectance between spectral color sensors 323 built into the printer apparatus 3 and a sensor serving as a reference. In contrast, in the third embodiment, an example is shown in which correction of horizontal scale (wavelength axis) error of spectral reflectance is further performed, in addition to correction of vertical scale error of spectral reflectance between sensors. As for horizontal scale correction in the third embodiment, it is assumed that wavelength correction based on an emission line of a calibration light source is performed.

There are cases where minute wavelength shift occurs between sensor models (particularly, different models). FIG. 10 shows the concept of vertical scale error (spectral reflectance shift) δr and horizontal scale error (wavelength shift) δw between measured values 1 serving as the reference and measured values 2 serving as the correction target. Reflectance correlation-based correction for each wavelength shown in the above-mentioned first and second embodiments is predicated on there not being wavelength shift between sensors. Thus, in the case where horizontal scale error δw occurs between the measured values 1 and the measured values 2, fitting the optical spectrum of the correction target to the reference with high accuracy with only vertical scale correction is problematic. Thus, in case where vertical scale error and horizontal scale error occur, the vertical scale needs to be aligned after first aligning the horizontal scale (wavelength direction).

Sensor Model Difference Correction

Hereinafter, processing for correcting sensor model difference in the third embodiment is described in detail. The sensor model difference correction processing in the third embodiment is divided into horizontal scale correction and vertical scale correction, with the latter vertical scale processing being equivalent to the above-mentioned first or second embodiment. That is, the third embodiment is characterized by horizontal scale correction being performed prior to vertical scale correction according to the first or second embodiment being implemented.

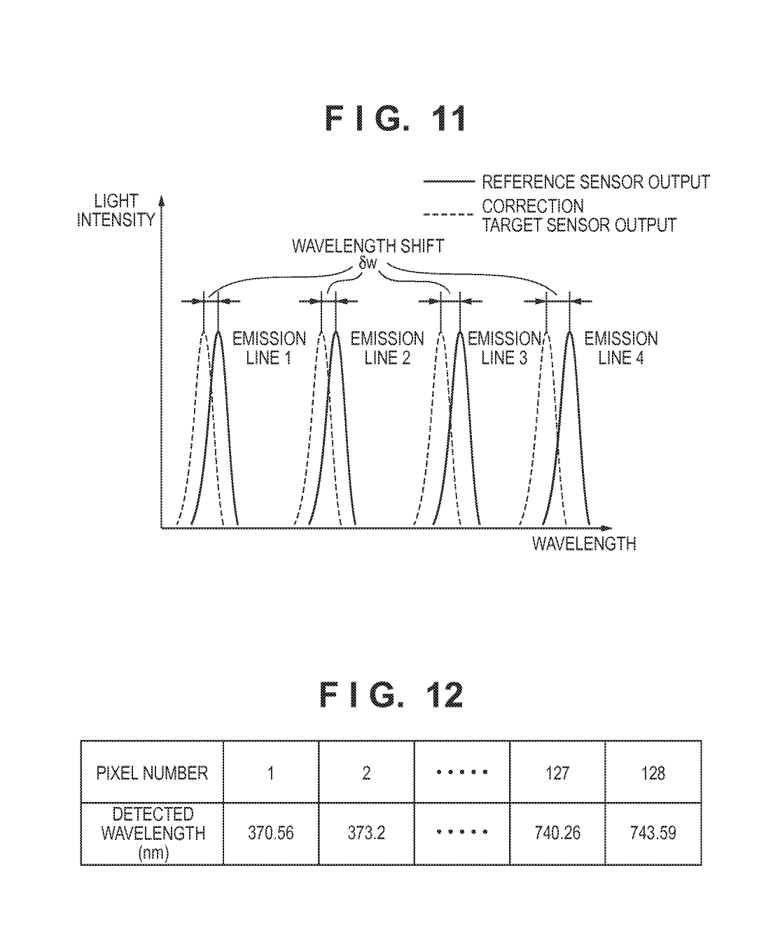

Here, horizontal scale correction processing in the third embodiment is described. First, the light of a wavelength calibration light source is measured in both a reference unit and a correction target unit, and light intensity distributions are obtained. Here, the same light is measured by the reference unit and the correction target unit. FIG. 11 shows example output of each sensor in the case where the light of the wavelength calibration light source was measured with four sensors. According to FIG. 11, it can be seen that a shift δw in the wavelength direction occurs in each of the four obtained emission lines (waveform peaks) of the wavelength calibration light.

Next, wavelength shift between sensors is detected from the obtained emission lines of the wavelength calibration light, and the correction for aligning the wavelength axes of the reference unit and the correction target unit is performed. Specifically, a correspondence table (FIG. 12) of sensor pixel positions and detected wavelengths is modified from relative shift information on the waveform peaks of the emission lines, such that the peak wavelengths of the emission lines are aligned. Generally in a spectral color sensor, pixel positions of the light-receiving element and wavelengths of light that are detected are associated in advance using a correspondence table such as shown in FIG. 12. This correspondence table is stored in a memory (not shown) in the sensor signal processing unit 324, and is used in wavelength allocation processing for allocating wavelengths to pixel data at the time of calculating spectral reflectance. Accordingly wavelength shift can be corrected by modifying the correspondence relation between pixel number and wavelength in the correspondence table with the reference sensor output as the reference wavelength, such that the wavelength shift of the correction target unit is eliminated.

After correction in the horizontal scale direction between sensors (wavelength correction) has been performed as described above, vertical scale correction is performed; that is, wavelength-specific correlation curves between the reference unit and the correction target unit according to the above-mentioned first or second embodiment are acquired, and the sensor output of the correction target unit is corrected.

According to the third embodiment as described above, sensor model difference can be corrected with higher accuracy, since error in the wavelength direction is also corrected, in addition to error in the spectral reflectance direction between a reference unit and a correction target unit.

### Fourth Embodiment

Hereinafter, the fourth embodiment according to the present invention is described. In the above-mentioned third embodiment, an example is shown in which vertical scale error and horizontal scale error in the optical spectra of a reference unit and a correction target unit are corrected, with an example being shown in which the emission line of a calibration light source is used as a technique for performing horizontal scale correction in particular. In contrast in the fourth embodiment, an example is shown in which a slope region of spectral reflectance is used, as a technique for performing horizontal scale correction.

The fourth embodiment is further characterized by iterative control of vertical scale correction and horizontal scale correction being performed.

Sensor Model Difference Correction

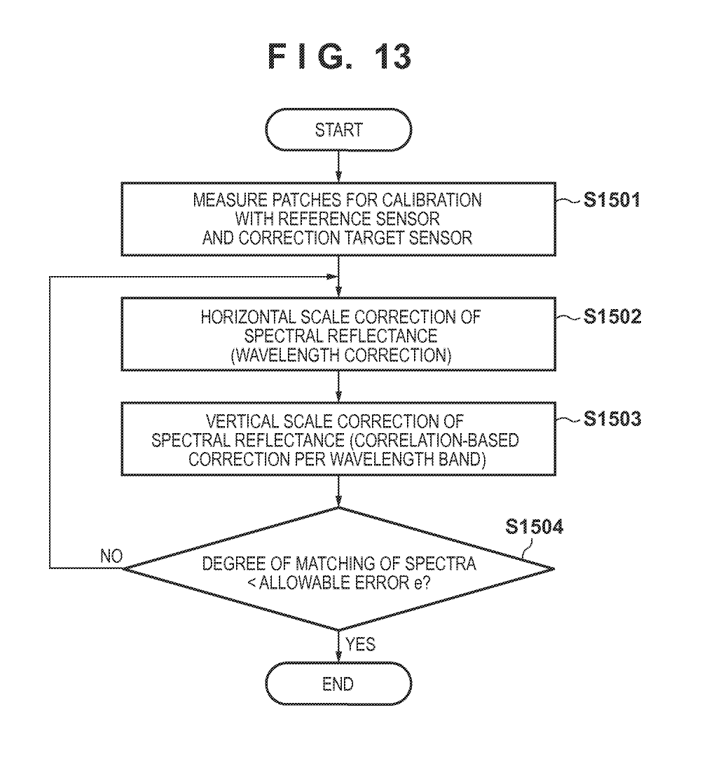

Hereinafter, processing for correcting sensor model difference in the fourth embodiment is described in detail using the flowchart of FIG. 13.

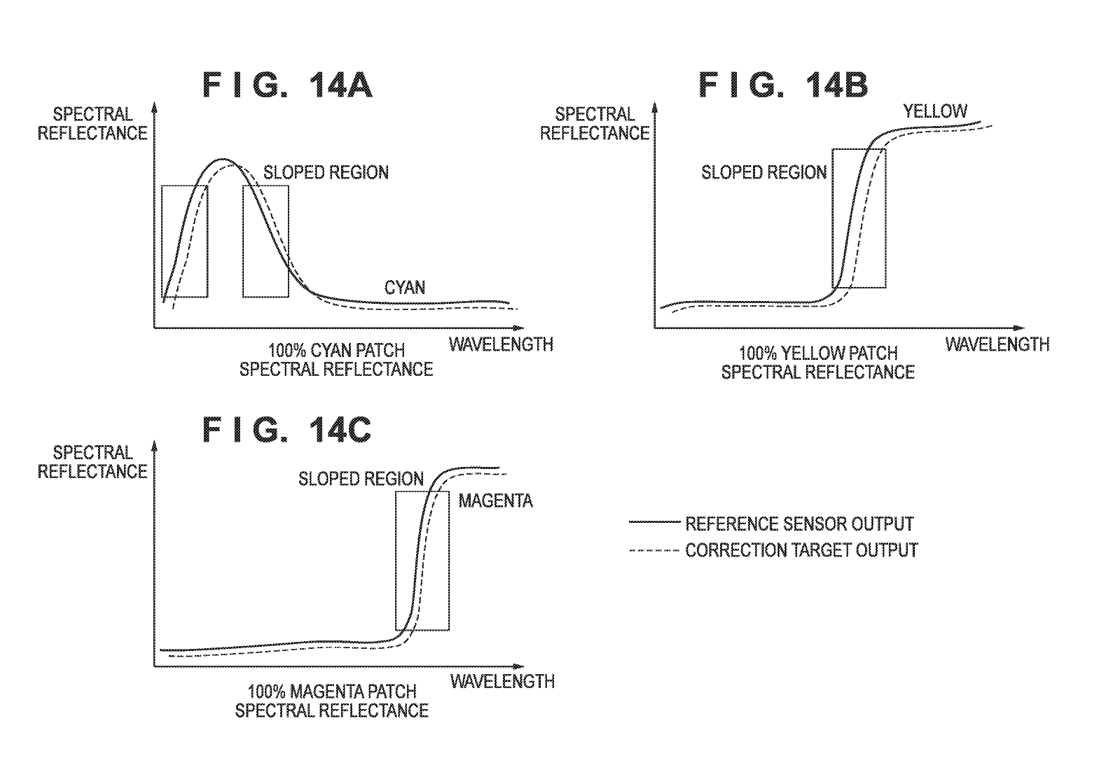

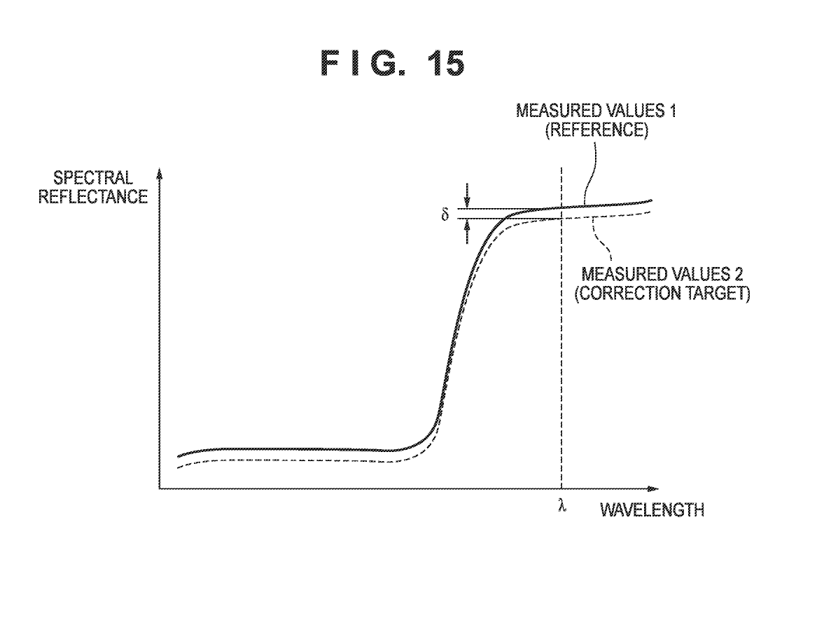

First, in S1501, the same light, that is, the same reflected light from the patches for calibration is measured with the reference unit and the correction target unit, and the spectral reflectances thereof are obtained. The patches for calibration are constituted by patches for horizontal scale correction and patches for vertical scale correction. As for the patches for horizontal scale calibration, patches that include a steeply sloped region in which the curve of spectral reflectance presents a steep slope are used. For example, a high-saturation 100% density cyan patch, a 100% density magenta patch, a 100% density yellow patch and the like as respectively shown in FIGS. 14A-C are used. As for the patches for vertical scale correction, gray patches consisting of N steps of 0-100% monochrome black are used, similarly to the first embodiment, for example.

Next, in S1502, shift in the horizontal scale direction is corrected, from the sloped regions of the spectral reflectances in the patches for horizontal scale correction obtained at S1501. Specifically, the correspondence table (FIG. 12) of sensor pixel positions and detected wavelengths held by the correction target unit is modified from the relative shift information in the sloped regions of the spectral reflectances, such that the sloped regions are fitted. Horizontal scale correction (wavelength correction) between the reference unit and the correction target unit is thereby performed. Here, wavelength correction is also similarly performed on the measurement results of the patches for vertical scale correction, as a result of the correspondence table being updated. Note that at S1502 correction of shift in the horizontal scale direction is performed so as to match the sloped regions of the spectral reflectances, but, strictly speaking, slight wavelength shift remains under the influence of shift in the vertical scale direction. Thus in the fourth embodiment, error between spectral reflectances is reduced to within an allowable range by repeatedly performing vertical scale correction and horizontal scale correction as mentioned later.

Next, in S1503, shift in the vertical scale direction is corrected, based on the spectral reflectances after the wavelength correction of S1502 has been applied to the measurement results of the patches for vertical scale correction obtained at S1501. That is, wavelength-specific correlation curves between the reference unit and the correction target unit according to the above-mentioned first or second embodiment are acquired, and the sensor output of the correction target unit is corrected.

In S1504, the degree of matching of the spectral reflectance corrected at S1503 is computed. As for the method of calculating this degree of matching, a known method can applied such as simply taking the difference, for example, and any technique may be used. If the calculated degree of matching is in a prescribed allowable range (or smaller than an allowable error e), the correction processing is ended, but if the degree of matching is outside the allowable range, the processing returns to S1502, and the above-mentioned horizontal scale correction and vertical scale correction are repeated. That is, the correspondence table for horizontal scale correction at the point in time when the degree of matching falls within the allowable range and the correction coefficients for vertical scale correction are applied to horizontal and vertical scale correction when calibration is performed. The wavelength correction (S1502) and the correlation-based correction per wavelength band (S1503) are interchangeable in FIG.13.

According to the fourth embodiment as described above, shift in the vertical scale direction and shift in the horizontal scale direction of the spectral reflectances of the reference unit and the correction target unit can be corrected with high accuracy.

Note that although an example is shown in the fourth embodiment in which a sloped region of spectral reflectance is used as a technique for correcting the horizontal scale difference (wavelength shift) of spectral reflectance, other techniques may naturally be used. Also, horizontal scale correction may be performed after vertical scale correction. Also, although an example was shown in which the degree of matching with a reference unit is calculated on the result of having performed both of horizontal scale correction and vertical scale correction on the correction target unit, a configuration may be adopted in which the degree of matching is calculated on only the vertical scale correction result in the above-mentioned first and second embodiments. That is, in the first and second embodiments, vertical scale correction can be repeated until the degree of matching falls within an allowable range.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2010-277429, filed Dec. 13, 2010 and 2011-253138, filed Nov. 18, 2011, which are hereby incorporated by reference herein in their entirety.

What is claimed is:

1. A color processing apparatus comprising:
a first input unit configured to input a reference spectral reflectance obtained by measuring a patch image with a spectrophotometer serving as a reference unit;
a second input unit configured to input a correction target spectral reflectance obtained by measuring the patch image with a spectrophotometer serving as a correction target unit;
a correction coefficient generation unit configured to generate a correction coefficient between the correction target spectral reflectance and the reference spectral reflectance, for each wavelength; and
a correction unit configured to correct, for each wavelength, the spectral reflectance measured by the correction target unit, using the correction coefficient.

2. The color processing apparatus according to claim 1,
wherein said first input unit is further configured to input the reference spectral reflectance for each of a plurality of patch images having mutually different densities,
said second input unit is further configured to input the correction target spectral reflectance for each of the plurality of patch images,
said correction coefficient generation unit is further configured to, for each wavelength, acquire a group of first reflectances for said wavelength from the reference spectral reflectance for each of the plurality of patch images, acquire a group of second reflectances for said wavelength from the correction target spectral reflectance for each of the plurality of patch images, and generate the correction coefficient, such that the group of second reflectances approaches the group of first reflectances when the group of second reflectances is corrected using the correction coefficient.

3. The color processing apparatus according to claim 2,
wherein said correction coefficient generation unit is further configured to, for each of the plurality of patch images, plot coordinates represented by reflectances included in the group of first reflectances and reflectances included in the group of second reflectances, and calculate a fitted curve, wherein a coefficient of the fitted curve is used as the correction coefficient.

4. The color processing apparatus according to claim 2,
wherein the group of first reflectances that is used by the correction coefficient generation unit includes more smaller reflectances than larger reflectances for at least one wavelength.

5. The color processing apparatus according to claim 1,
wherein said correction coefficient generation unit is further configured to generate, as the correction coefficient, a coefficient representing a correlation curve with the reference spectral reflectance for each correction target spectral reflectance, for each wavelength.

6. The color processing apparatus according to claim 2,
wherein the correlation curve is represented as a polynomial equation, and the polynomial equation differs for each wavelength.

7. The color processing apparatus according to claim 1,
wherein a plurality of spectrophotometers are provided internally to the color processing apparatus, and
one of the plurality of spectrophotometers serves as the reference unit and the other spectrophotometers serve as the correction target unit.

8. The color processing apparatus according to claim 1,
wherein a spectrophotometer connected externally to the color processing apparatus serves as the reference unit, and a spectrophotometer provided internally to the color processing apparatus serves as the correction target unit.

9. The color processing apparatus according to claim 1,
wherein the patch image is composed of a plurality of monochrome black patches having mutually different gradations.

10. The color processing apparatus according to claim 1, further comprising a waveform correction unit configured to correct a correspondence relation between a waveform and a pixel position of a light-receiving element provided in the spectrophotometers, based on a result of the same light being measured by the reference unit and the correction target unit.

11. The color processing apparatus according to claim 1, further comprising an iterative control unit configured to calculate a degree of matching of a spectral reflectance corrected by the correction unit with respect to the reference spectral reflectance, and perform control so as to repeat generation of the correction coefficient by the correction coefficient generation unit, with the corrected spectral reflectance as the correction target spectral reflectance, until the degree of matching is within a prescribed allowable range.

12. The color processing apparatus according to claim 1, further comprising a detection unit configured to perform measurement failure detection with respect to at least one of the reference spectral reflectance and the correction target spectral reflectance.

13. The color processing apparatus according to claim 12,
wherein in a case where the detection unit detects a measurement failure for a first wavelength of a first patch image, said correction coefficient generation unit is further configured to generate the correction coefficient using data other than measured data relating to the first wavelength of the first patch image.

14. A color processing method comprising the steps of:
inputting a reference spectral reflectance obtained by measuring a patch image with a spectrophotometer serving as a reference unit;
inputting a correction target spectral reflectance obtained by measuring the patch image with a spectrophotometer serving as a correction target unit;
generating a correction coefficient between the correction target spectral reflectance and the reference spectral reflectance, for each wavelength; and
correcting, for each wavelength, the spectral reflectance measured by the correction target unit, using the correction coefficient.

15. A storage medium storing a program that, by being executed with a processor of the color processing apparatus according to claim 1, causes the processor to function as each unit of the color processing apparatus.
